(19) United States
(12) Patent Application Publication
(10) Pub. No.: US 2010/0042508 A1
(43) Pub. Date: Feb. 18, 2010

(54) Method and Apparatus for Implementing a Peer to Peer Transaction System

(76) Inventors: Reza Bundy, Venice, CA (US); John Shiple, Los Angeles, CA (US); Mark Liu, Venice, CA (US)

Correspondence Address: DLA PIPER US LLP, 1999 AVENUE OF THE STARS, SUITE 400, LOS ANGELES, CA, 90067-6023, US

(21) Appl. No.: 12/191,994

(22) Filed: Aug. 14, 2008

(51) Int. Cl. G06Q 30/00; G06Q 50/00

(52) U.S. Cl. 705/26; 705/400

(57) ABSTRACT

The system provides a method an apparatus for implementing a peer to peer transaction system. The system includes an online system of marketing and pricing that optimizes saleability and profit, limits access of strangers to personal spaces, limits the likelihood of unqualified buyers, provides appropriate paperwork automatically, and reduces the cycle time of offer and sale. The system also provides trustworthy information to a buyer of physical condition and title, as well as resources normally only available in a commercial transaction.

### BACKGROUND OF THE SYSTEM

There have been a number of system to allow peer to peer transaction of products and services. By peer to peer in this application we refer to non-commercial sales between individuals. One example of a peer to peer transaction is the purchase or sale of an automobile between an owner of the automobile and an individual. In the past this has involved the placing of classified advertisements in some media such as a newspaper, a used vehicle focused publication, or on the internet. Some transactions are implemented via auction sites such as eBay.

There are a number of disadvantages of prior art systems for implementing peer to peer transactions. On the seller side, problems include marketing, exposure to strangers, multiple contacts from buyers, unqualified buyers, unfamiliar paperwork, and long cycle times. On the buyer side, problems include connecting with the seller, unavailability of the vehicle, unknown level of trust in the condition of the vehicle, lack of commercial financing and insurance, and lack of clean title.

### SUMMARY OF THE SYSTEM

The system provides a method an apparatus for implementing a peer to peer transaction system. The system includes an online system of marketing and pricing that optimizes saleability and profit, limits access of strangers to personal spaces, limits the likelihood of unqualified buyers, provides appropriate paperwork automatically, and reduces the cycle time of offer and sale. The system also provides trustworthy information to a buyer of physical condition and title, as well as resources normally only available in a commercial transaction.

### BRIEF DESCRIPTION OF THE DRAWINGS

FIG. 1 is a flow diagram illustrating the functional operation of the system from the seller's viewpoint.

FIG. 2 is a flow diagram illustrating the operation of the profile step of the system.

FIG. 3 is an embodiment of a vehicle information entry system.

FIG. 4 is an example of a query to the seller in an embodiment of the system.

FIG. 5 is an example of data entry in one embodiment of the system.

FIG. 6 is an example of a price selection menu in an embodiment of the system.

FIG. 7 illustrates one embodiment of the number of options that a seller can choose for listing and advertising using the system.

FIG. 8 is a flow diagram illustrating an embodiment of the system where a potential buyer requests an inspection of a vehicle.

FIG. 9 is a flow diagram illustrating a self warranty operation in one embodiment of the system.

FIG. 10 is a flow diagram illustrating transaction completion in an embodiment of the system.

FIG. 11 is an example hardware embodiment of the system.

### DETAILED DESCRIPTION OF THE SYSTEM

The system provides a method and apparatus for the implementation of a transaction system. In the examples below, the system is described in connection with transactions involving automobiles. However, the system is not limited to such products and may be implemented with any goods and/or services without departing from the scope of the system.

The system provides useful tools for the seller, the buyer, and for completing the transaction. These tools and methods will be described below.

Seller

We will initially describe the operation of the system from the standpoint of the seller. When a seller wishes to sell an automobile, the seller typically places an advertisement. This ad may be on the vehicle itself in the form of a placard, it may be posted publicly in a high traffic area such as a shopping center or busy street, it may be placed in a periodical such as a newspaper, it may be placed online, or it may be placed in any combination of the above. Another option for a seller is to use an online auction site, such as eBay, as a tool for selling the vehicle. A problem for the seller is not only choosing which medium in which to advertise the vehicle, but how to phrase the advertisement for maximum effect and how to price the vehicle properly for likely sale but adequate return.

Many sellers will rely on other ads that they have seen and attempt to copy an ad when marketing their own vehicle. In addition, a seller may rely on a third party valuation site, such as Kelly Blue Book (www.kbb.com) as a source for pricing information. Often the seller will overestimate or underestimate the condition and value of their vehicle and thus choose an in appropriate price that either delays or prevents sale, or costs the seller revenue.

The system automatically walks a seller through all the steps needed to market the vehicle in a professional manner that maximizes peer to peer sales potential. The system includes profiling of the vehicle, imaging, certification, listing and advertising, tracking and management, and buyer screening and negotiation.

Operation of the System (Seller)

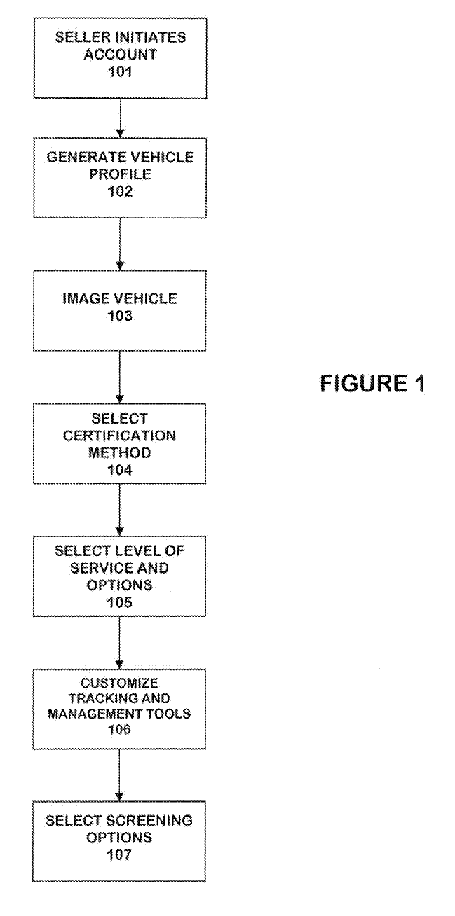

FIG. 1 is a flow diagram illustrating the functional operation of the system from the seller's viewpoint. At step 101 the seller signs up and creates an account in the system. At step 102 the vehicle profile is generated. In one embodiment of the system, the vehicle profile comprises a vehicle “biography” and a selling price. The system includes a method for aiding the seller in generating a biography that is useful for the particular vehicle and area where the vehicle is to be sold, and provides automatically generated information that allows the seller to intelligently price the vehicle.

At step 103 the system directs the seller to image the vehicle. This may be by uploading photographs of the vehicle or by requesting a service package where professional photographs are taken. Audio files, three-dimensional “virtual walkthroughs”, and other types of vehicle imaging content may be uploaded as well. At step 104 the seller is prompted to select a certification method for the vehicle. This allows the seller to choose from a plurality of certification methods that have different pricing structures and may be initiated by the buyer instead of the seller. At step 105 the system presents selectable options associated with the level of service that the user has selected and includes choices for listing and advertising the vehicle. At step 106 the seller is given a chance to customize and select tracking and management tools. At step 107 the seller selects buyer screening and negotiating options, including call center services.

Profile

Auto-Biogaphy

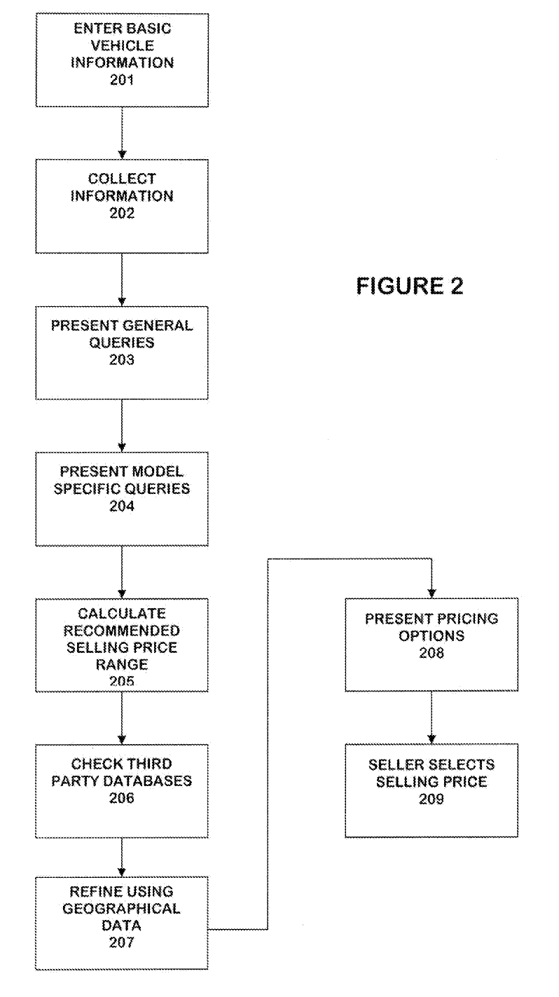

As noted above, the system prompts the user to profile the vehicle at step 102. This profile comprises a biography of the vehicle as well as selecting a selling price for the vehicle. FIG. 2 is a flow diagram illustrating the operation of the profile step of the system. At step 201 the seller enters basic information about the vehicle such as year, make, model and some other basic questions. This step collects information likely to be known by the seller that will assist in directing the seller in later steps of the process.

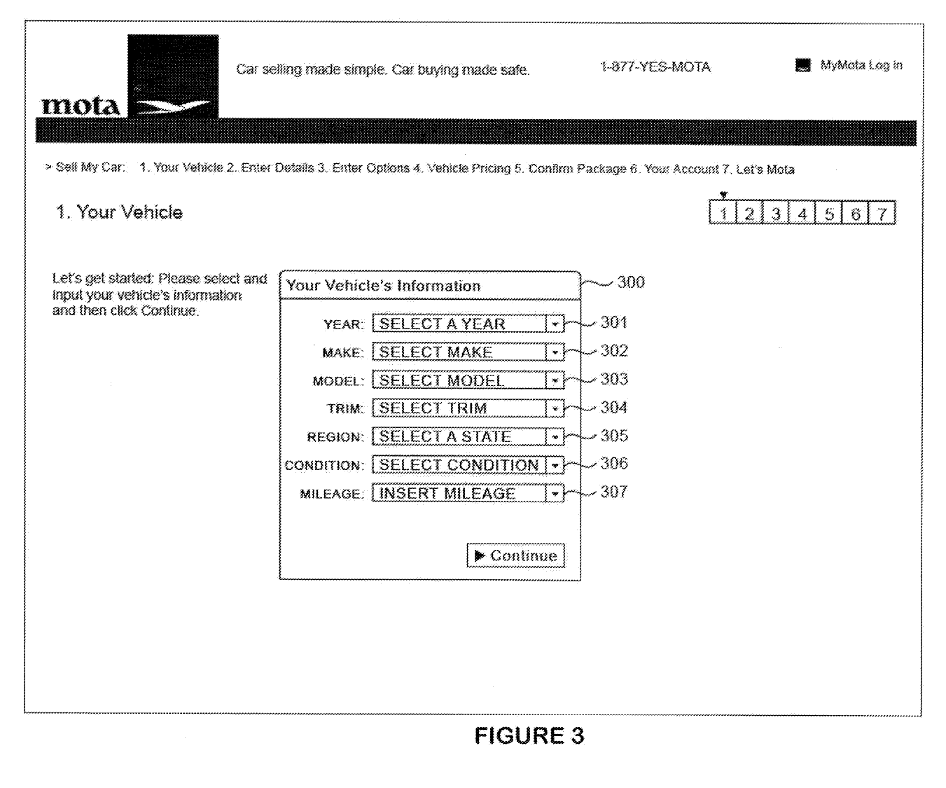

Referring briefly to FIG. 3, one embodiment of a vehicle information entry system 300 for implementing step 201 is illustrated. Here the seller chooses the year 301, make 302, and model 303 of the vehicle to be sold. In one embodiment, completion of the fields is done from top down, with each answer modifying lower fields so that appropriate choices are provided. For example, after the make 302 (e.g. Ford, Mercedes) is selected, the model menu 303 is populated only with models from that maker and made in the year selected at field 301. Similarly, the trim field 304 is populated only with options for that model of that year. The region (e.g. state) field 305 will affect later options presented to the seller as well (including some of the questions related to the biography of the vehicle as well as the price). The condition field 306 is often misunderstood by the seller but later questions that are customized for the vehicle aid in correctly describing the condition of the vehicle. Finally the seller enters the mileage 307 and proceeds to the next step.

Returning to FIG. 2, at step 202 the system collects the initial data entered by the seller in step 201 and retrieves a series of interactive queries for the seller that aid in providing more detail for the biography of the vehicle.

At step 203 the seller is presented with a series of general queries. In one embodiment, these questions are focused on the condition of the vehicle (interior, exterior, and mechanical), the everyday use of the vehicle, maintenance of the vehicle, extras, and a space for additional information that the seller may think is important.

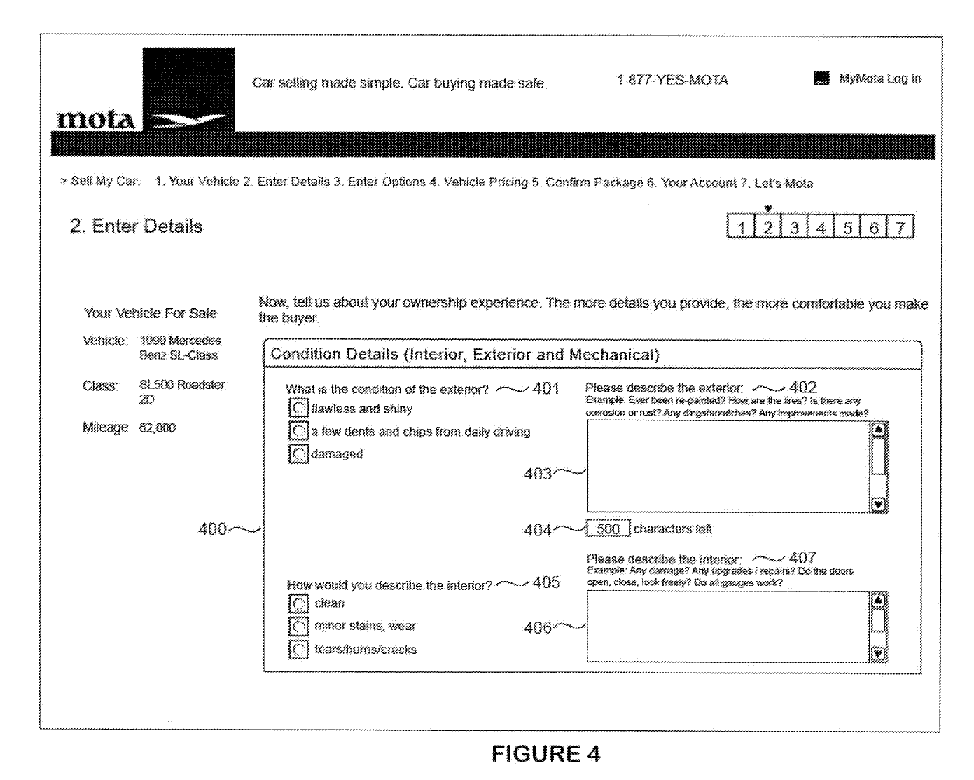

The system provides explanations of the queries and includes a text box where the seller can enter additional information as desired. Referring now to FIG. 4, and example of a query is illustrated. Query 400 relates to the condition of the vehicle exterior and interior. The seller is presented with three checkboxes 401 to generally describe the exterior of the vehicle. The user can simply select one of the boxes and proceed to the next query. Alternatively, the user can enter text into text box 403 to more fully describe the vehicle. This detail supplements (and possibly corrects) the choice of condition 306 selected in step 201.

The system provides helpful hints 402 about items that may be of interest. The seller can simply describe items of the vehicle that match up with the hints above a query box to provide a more useful biography of the vehicle. Alternatively, the seller can choose their own additional description if desired. In one embodiment, the system indicates how many characters the seller can still enter in the text box at box 404. In one embodiment, the system limits the amount of text the seller can enter as a method of keeping the vehicle biography more readable.

This system of guiding and directing the seller, as well as limiting the number of words, results in a vehicle biography that includes the kind of information that is useful to a buyer and/or in marketing a vehicle. Many times sellers do not know the kind or amount of information to include in a vehicle description, so the system removes the guesswork and uncertainty.

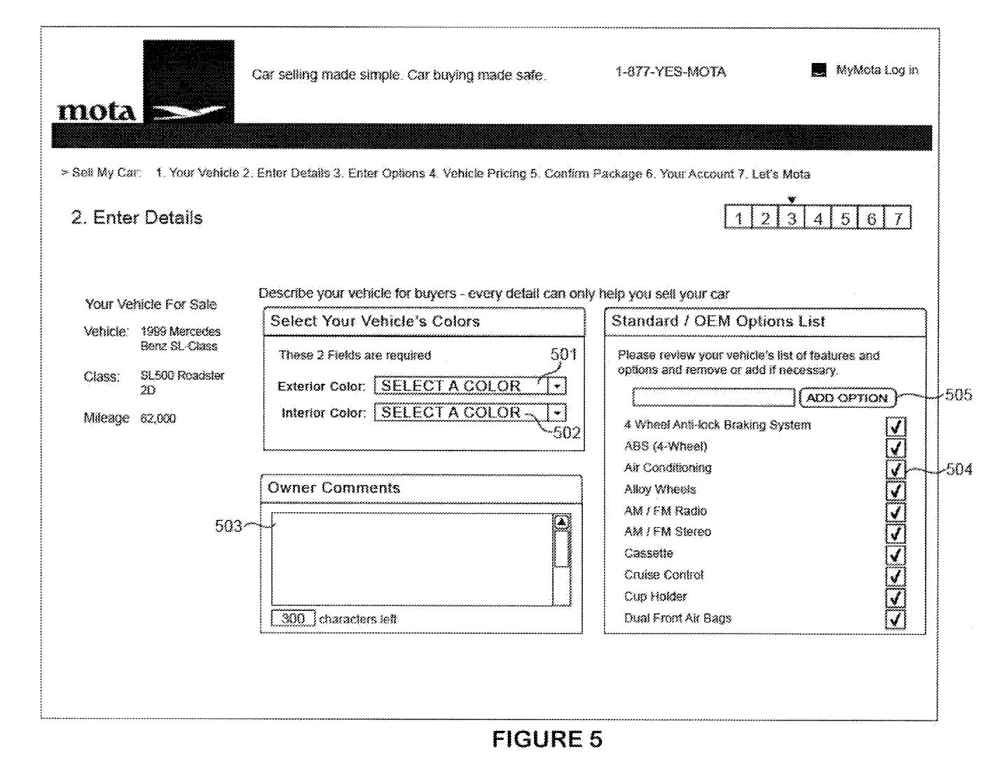

At step 204 the seller is presented with a series of queries that are specific to the year, make and model of the vehicle identified in step 201. Step 204 allows the user to specify certain descriptive features of the vehicle such as interior and exterior color, options, and any additional options or customizations that the vehicle may have. Referring briefly to FIG. 5, the system presents the user with data entry 500 including required fields for exterior color 501 and interior color 502. If the color of the vehicle is not found in available colors of the pull down lists, the user can describe the color in text field 503. Region 504 lists the available options for the year, make, model, and trim level selected by the seller. The seller can de-select any of the options that do not apply and use field 505 to add options that may not be reflected in the list.

Pricing

At step 205 the system uses the data provided in the auto-biography to find a recommended price for the vehicle. The system checks third party databases at step 206. These databases can be sites such as Kelly Blue Book as well as eBay, on-line advertisements, or reported sales data from government resources. The system uses geographical data at step 207 to further customize the pricing algorithm. At step 208 the system provides the seller with pricing options including a calculated minimum selling price. At step 209 the seller selects a price and confirms it to the system.

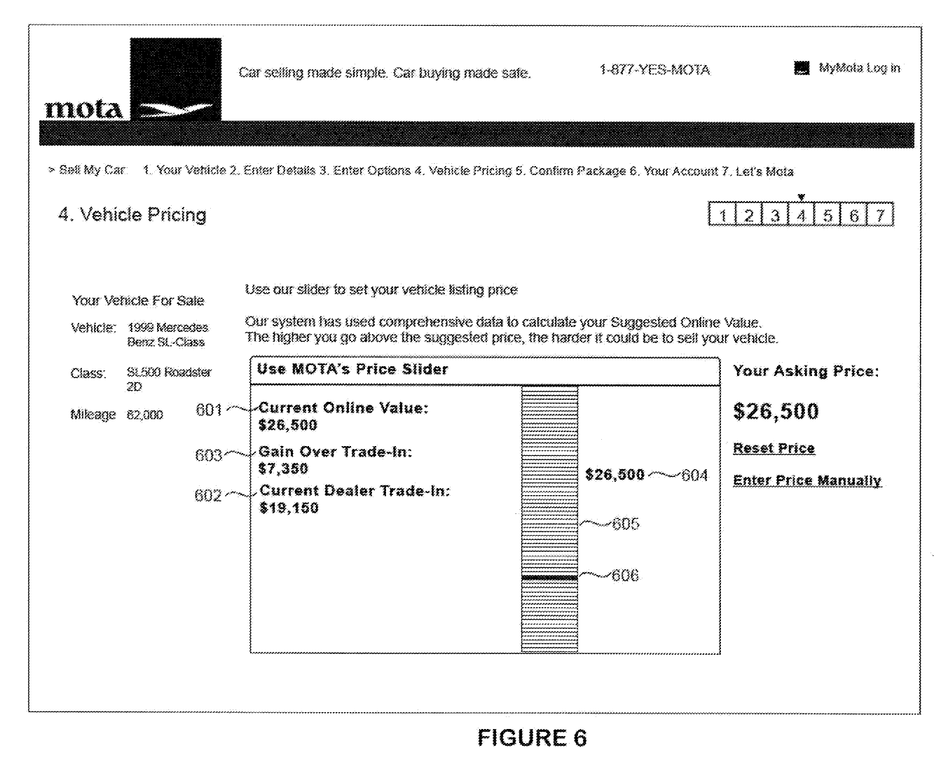

FIG. 6 is an example of a price selection menu in an embodiment of the system. The seller is presented with an estimated sales price 601 based on available data and vehicle profile. The current estimated trade-in value 602 is also provided. The system then provides the gain 603 of a peer-to-peer sale over a trade-in. This is useful information as it allows the seller to realize how flexible in the price to be while still achieving an advantage over simply trading in the vehicle. The menu allows the seller to grab the sales price slider 604 to the right of the bar 605 and simply move it up and down to set a selling price. The price displayed in the slider 604 changes automatically as the seller moves the slider 604 up and down. In addition, the gain value 603 is automatically recalculated as the slider moves so the seller can see how much of an advantage is achieved over trade-in for each new price.

A low price indicator bar 606 is defined on the slider scale to represent a minimum price below which the user should not consider setting the sales price. This minimum sales price is calculated by the system and is based on the profile information, location, time of year, and other relevant information, including the selling frequency of vehicles of that type and the number of competing vehicles of the same type or same category. It should be noted that the seller is free to set a sales price below that line 606 if desired. In addition, the user can manually enter a price instead of using the slider 604.

Imaging

The system provides the seller the ability to include images of the vehicle in the listings the user may choose. In one embodiment the system provides the option of the seller to take their own pictures for use in the marketing of the vehicle. Optionally, the seller can optionally choose to have a professional third party photographer take images of the vehicle. As will be seen below in Listing and Advertising, the number of images that will accompany the vehicle depends on the selection by the seller of one of a plurality of listing options. Another embodiment of the system provides an option of the seller to take their own voice, record it over the telephone, and embed the generate audio clip in the marketing of the vehicle. Another embodiment of the system provides an option of the seller to upload videos or three-dimensional visualizations of the vehicle for use in the marketing of the vehicle.

Certification

One of the drawbacks in peer-to-peer sales is the lack of trustworthiness of the seller by the buyer The buyer may have doubts about the actual condition of the vehicle and may not want to rely on the word of the seller. If there is a problem with the vehicle, the buyer may have no one to pursue to correct any problems or misrepresentations regarding the vehicle. This limitation can tend to lead the buyer to purchase from a commercial party such as a dealer so that some level of both trustworthiness or future liability can be had. For some buyers who wish to take advantage of peer-to-peer sales, one approach has been to have a trusted mechanic inspect the vehicle and report on condition and problems. This leads to inconvenience in arranging to have the vehicle provided to the mechanic and delays while the mechanic inspects the vehicle. Another problem is when the vehicle is at a distance from the buyer. The buyer may not be able to arrange for the vehicle to be delivered to a known mechanic and is then in the position of needing to find a mechanic in another town or city or even state to perform the inspection.

The system provides a number of solutions for problems associated with certification. In one embodiment, the seller may choose to have an inspection performed and then make the vehicle inspection report (VIR) available on-line as part of the listing. In another embodiment, the seller may have a VIR prepared but charge a nominal fee to view the VIR. This will tend to self select those viewing the VIR to more serious purchasers.

In another embodiment, the system provides information about a vehicle inspection service that the buyer can elect to use to have an inspection performed. This serves to further self select serious buyers. This is a step that would normally be taken by a serious buyer but is often made difficult by distance from the seller. By providing information about an inspection service as well as a published price for the inspection, the guesswork is removed on the part of the buyer. An advantage of this third party inspection is that it may include a warranty of some sort on the inspection (e.g. 30 days) that may give comfort to a buyer who otherwise would be wary of a peer-to-peer sale.

In one embodiment, the system has a relationship with a known national entity for the inspections. For example, the system may have a relationship with an entity such as Pep Boys. This provides the buyer with an independent and trusted inspection service, as well as assurance that the buyer will have recourse to an ongoing enterprise if there is any dissatisfaction. In other instances, the system offers a plurality of inspection services to the buyer. The buyer can choose the inspection service with which the buyer is most comfortable and initiate the inspection process.

In addition to a VIR, the system also offers the option of providing a vehicle history report, such as those provided by CarFax or AutoHistory.

Listing and Advertising

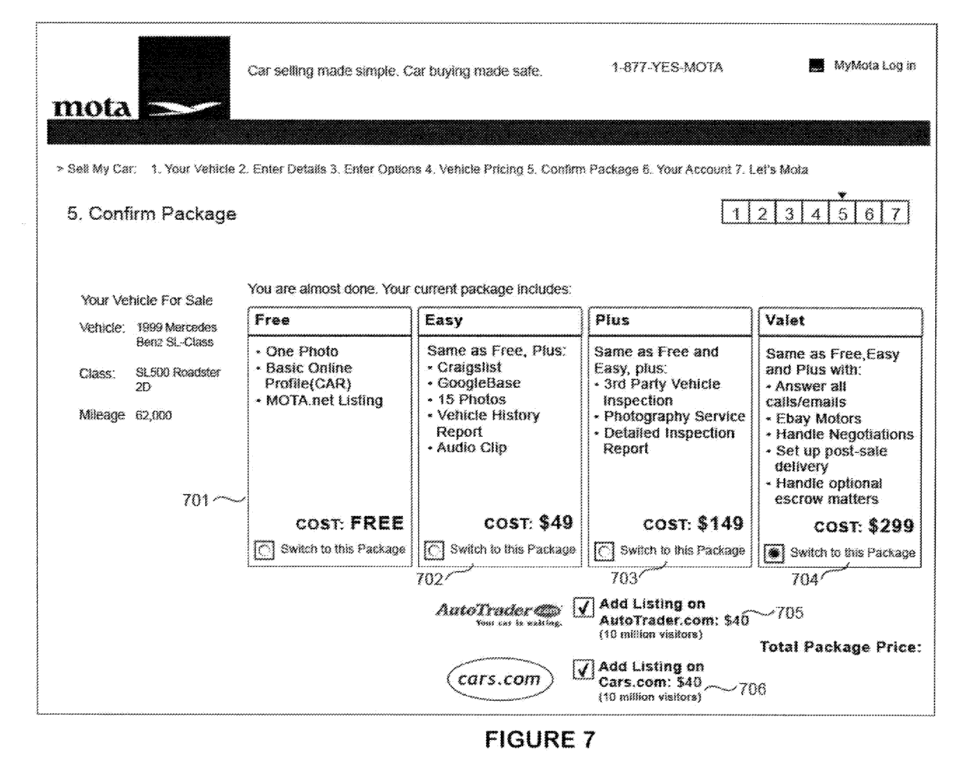

FIG. 7 illustrates one embodiment of the number of options that a seller can choose for listing and advertising using the system. The system provides in this embodiment four options 701, 702, 703, and 704. Option 701 is free to the seller in one embodiment and includes the night to include one image of the vehicle, the profile as generated by the interactive question process, and a listing on a vehicle listing service provided by the system (e.g. www.mota.net). Option 102 in this embodiment is an option that includes a fee for the seller (as do options 703 and 704). Option 702 includes additional listings (e.g. Craig's list and Google) as well as the right to include up to fifteen images. This option 702 includes all options of the earlier option 701 plus a vehicle history report and an audio clip.

The audio clip is a sound file that is included with the online listing of the vehicle. The seller is prompted to record a sound file describing the car but answering the highest frequency questions that buyers typically have about vehicles, particularly the vehicle on sale. Even with the extensive data gathered from the seller and made available to potential buyers, there are still questions that the buyer wishes to hear discussed by the seller. The system anticipates this need and prompts the seller to answer these questions in a recorded voice file. The voice file is attached to the listing and potential buyers can choose to listen to it if desired. The goal of each listing is to reduce the need for the buyer to have direct communication with the seller for as deep into the process as possible. In this manner, the seller will only deal with actual potential buyers, avoiding the annoyance of dealing with multiple people.

Option 703 includes a third party vehicle inspection that a buyer can access either for free or for a relatively nominal fee, at the user's discretion. This option 703 also includes a professional photography service that come to the seller, takes professional photographs for use in the listing, and selects the best photographs to lead to a sale. This option 703 also includes a detailed inspection report.

Option 704 is the top option in this embodiment. This option provides a service where the system handles all communications with buyers as well as negotiations (as instructed by the seller). This eliminates the risk to the seller of visits or communications by strangers. Even the delivery of the vehicle is handled by the system to avoid involvement by the seller. It also includes listing on additional services (e.g. eBay motors).

Regardless of the option selected, the seller has the ability to choose additional listing media such as AutoTrader.com 705 and Cars.com 706 for additional fees.

Tracking and Management

The system provides the ability to track and manage the sale of the vehicle so that effort by the seller is reduced. The system can handle email inquiries about the vehicle and forward them to the seller. This prevents the buyer from having access to the seller's personal information. When the system call handling option is selected, the seller is insulated from all buyer communication, even after the sale is completed. The seller need never have personal visits or communication from the buyer or potential buyers. This eliminates one of the prime prior art disadvantages of peer-to-peer vehicle sales, namely the discomfort and potential danger of interaction with and communication with strangers.

The system also provides other management operations. For example, in one embodiment, the system can track counteroffers to the sales price selected by the seller (if permitted). The system can compare these counteroffers to the selling price and make recommendations for adjusting the selling price. In addition, the system can track sales of similar vehicles in similar geographic areas and inform the seller of real world selling prices that may cause the seller to adjust the price (up or down).

Buyer

The buyer experience is also improved with the system. Some of the disadvantages of prior art peer-to-peer transactions from the buyer standpoint include lack of trustworthiness in the condition of the vehicle, lack of accessibility to the seller, inability to inspect the vehicle, lack of availability of financing, insurance, and warranty, and lack of recourse after a sale. The system provides improvements and solutions for all of these buyer disadvantages.

The buyer experience is in part defined by the options that the seller has selected and in part by the options that the buyer chooses to take advantage of. When the seller has selected the highest option level, the buyer is provided with the maximum amount of information about the vehicle including multiple images taken by a third party, a vehicle history report, and a VIR.

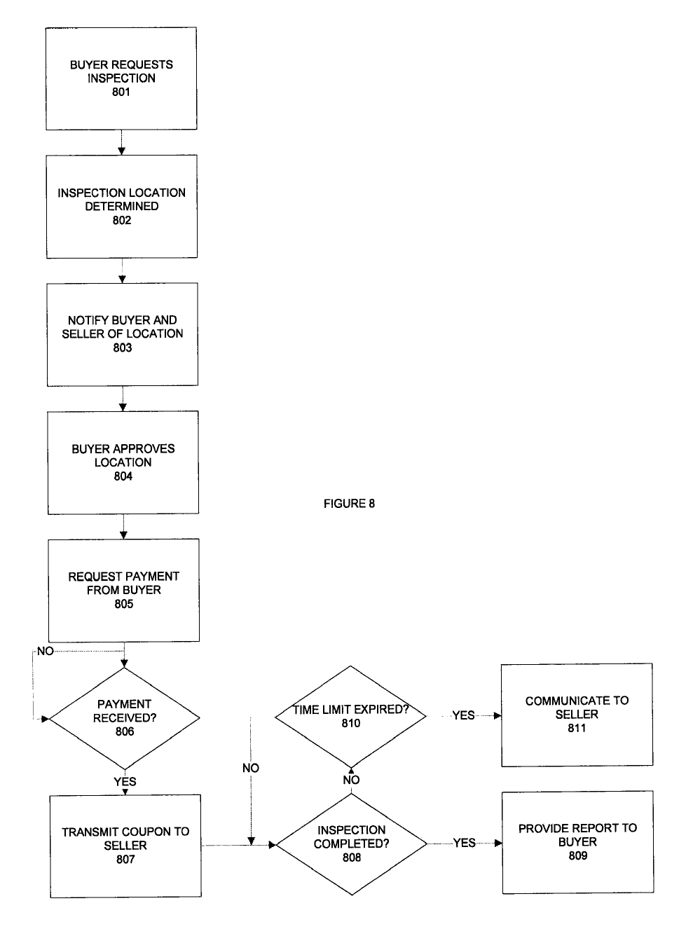

FIG. 8 is a flow diagram illustrating an embodiment of the system where a potential buyer requests an inspection of a vehicle. At step 801 a buyer indicates that an inspection is requested. At step 802 the system determines available inspection locations near the seller. The inspection location may be one pre-selected by the seller or may be an inspection location already in a partner relationship with the system and near the seller. (In one embodiment of the system, partnerships are formed with regional or national repair and parts centers, such as Pep Boys, Sears Automotive, Aamco, and others). After an inspection location has been determined, the system notifies the seller at step 803 of the inspection location. If the buyer approves the inspection location at step 804, the system requests payment from the buyer at step 805.

At decision block 806 the system determines if the payment has been received. If not, the system returns to step 805. If so, the system transmits a coupon to the seller at step 807. The coupon covers the expense of obtaining the vehicle inspection at the selected inspection location. The coupon also instructs the inspection location to forward a copy of the inspection results to the buyer at a provided address, or to the system via electronic transfer. The seller is encouraged to obtain the inspection quickly. The system sets a time limit within which the seller must schedule the inspection. At decision block 808 the system determines if the seller has had the car inspected. If so, the system provides the inspection report to the buyer at step 809.

If the seller has not had the vehicle inspected, the system proceeds to decision block 810 and checks to see if the time limit for inspection has expired. If not, the system returns to step 808. If so, the system proceeds to step 811 and communicates to the seller that the deadline has passed. The consequences for failing to have an inspection may include a termination of the listing, a penalty fee, or some other consequence designed to encourage participation on the part of the seller. In one embodiment, the seller need only make the vehicle available and a system representative will transport the vehicle to the inspection location.

Self Warranting

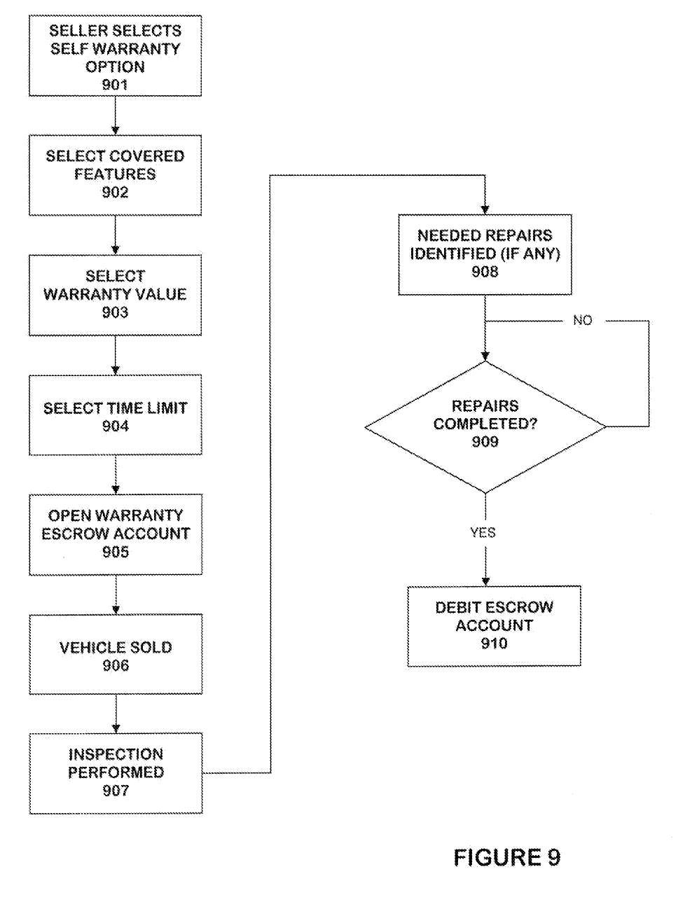

In one embodiment of the system, the seller designates in the sellers listing that the seller will self warrant the vehicle. This is to remove the need to have an inspection performed prior to sale and to facilitate more rapid turnaround from listing to sale. The seller will provide disclosure of possible problems and identify certain items on the vehicle that the seller will warrant. In the flow diagram of FIG. 9, the seller chooses self warranty at step 901. At step 902 the seller selects those features of the vehicle to be covered by the warranty. At step 903 the seller selects the total amount of warranty value (e.g. $2,000.00) and at step 904 the time limit of the warranty (e.g. 3 days). At step 905 the system creates an escrow account for the warranty amount to be held for the time limit of the warranty.

At step 906 the vehicle is sold to a buyer and the buyer receives the warranty and a coupon for an inspection at an approved inspection location. The buyer then has the inspection performed at step 907. At block 908 the report indicates repairs necessary on the vehicle. At decision block 909 it is determined if any of the indicated repairs are covered by the warranty. If so, at step 910 the escrow account is debited for those items up to the total warranty (optionally minus a deductible amount, e.g. $500.00). The remainder, if any, of the escrow amount is returned to the seller. If none of the indicated repairs are covered by the warranty, the escrow amount is returned to the seller and the transaction is complete.

The advantage to the seller of providing a self warranty is that the seller is in the best position to know the reliability and condition of the vehicle. At the same time, the escrowed warranty amount takes the question of trust out of the hands of the buyer. A buyer is not incetivized to get a car inspection when the buyer is not sure if they will be the successful bidder. The self-warranty option means that only the winning bidder needs to pay for an inspection and yet has a source of compensation if things are not as they are described.

Complete Transaction

The system also provides additional features that fill in the gaps between a commercial transaction and a peer-to-peer transaction. The system provides a way to handle paperwork, title transfer, transport of the vehicle (if needed), financing, insurance, and post-sale continuing warranty.

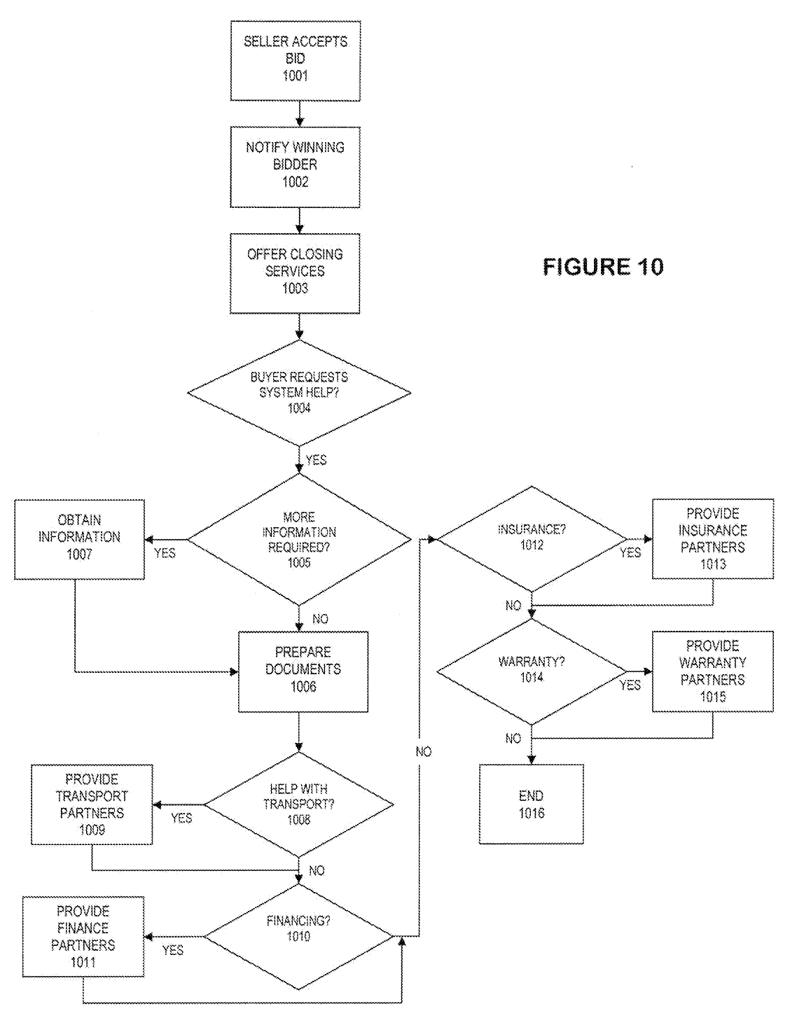

FIG. 10 is a flow diagram illustrating how the system operates at the close of a transaction. At step 1001 a seller accepts a bid which ends the selling part of the process. At step 1002 the system notifies the buyer that they buyer has won the bid and can now transfer ownership of the vehicle. At step 1003 the system offers the buyer the opportunity to participate in a number of closing services offered by the system. At decision block 1004 it is determined if the buyer wants the system to handle the paperwork of the transaction. If so, the system checks at decision block 1005 if it has the necessary information to prepare the transfer documents. If so, the system proceeds to prepare the transfer documents at step 1006.

If the system needs information at step 1005, it requests data from the buyer at step 1007 and then proceeds to step 1006. If the buyer does not want assistance with the paperwork at step 1004 or after step 1006, the system determines if the buyer needs assistance with the transport of the vehicle at step 1008. If so, the system provides the buyer at step 1009 with the opportunity to contract with a system partner for transport of the vehicle.

If not, the system proceeds to step 1010 to determine if the buyer needs financing to complete the transaction. If so, the system includes financing options and initiates the financing process at step 1011. This is an advantage that previously only commercial dealerships offered to vehicle purchasers. If the buyer does not need financing at step 1010, the system proceeds to step 1012 to determine if the buyer needs vehicle insurance. If so, the system offers at step 1013 insurance options from system partners. If not, the system determines at step 1014 if the buyer is interested in a continuing warranty on the vehicle. This type of service is usually only offered by commercial dealerships. If the buyer desires a warranty, at step 1015 the system provides options from system partners. If not, the system exits and the sale is concluded as described below.

If the buyer does not want to take advantage of the services offered by the system, the buyer can complete the transaction under the terms established by the seller. The seller can require a particular form of payment (e.g. cashier's check, certified check, wire transfer, cash, etc.). The seller may also wish to remain out of contact with the buyer and have transactions finalized by system representatives. In that case, the system arranges payment, title transfer, and physical delivery of the vehicle. If the seller handles it personally, the system allows the buyer and seller to be in communication through the system through non-system channels as desired.

Embodiment of Computer Execution Environment (Hardware)

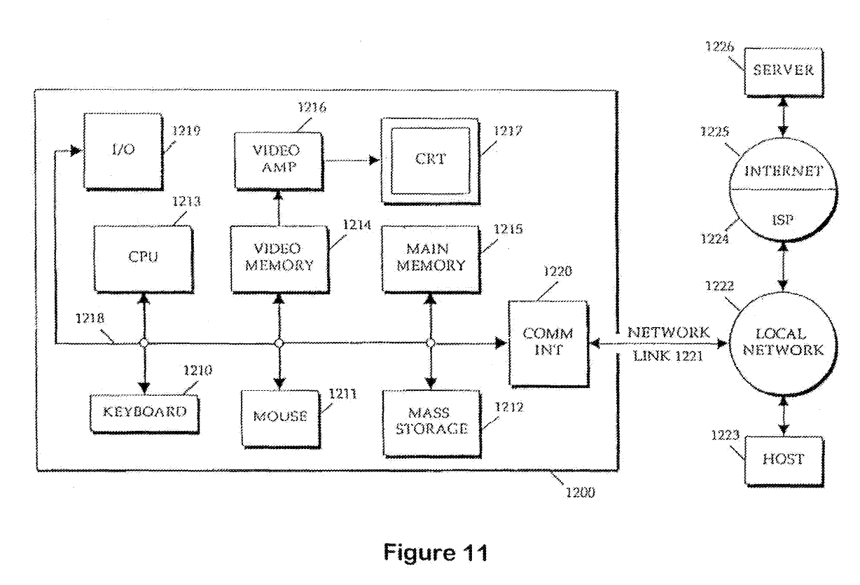

An embodiment of the system can be implemented as computer software in the form of computer readable program code executed in a general purpose computing environment such as environment 1200 illustrated in FIG. 11, or in the form of bytecode class files executable within a Java™ run time environment running in such an environment, or in the form of bytecodes running on a processor (or devices enabled to process bytecodes) existing in a distributed environment (e.g., one or more processors on a network). The system may also be implemented on any suitable computing device such as a PDA, mobile phone, mobile computing device, as a software service hosted on a server, an ethereal network based implementation, or any other suitable processing environment.

In the system of FIG. 11, a keyboard 1210 and mouse 1211 are coupled to a bidirectional system bus 1218. The keyboard and mouse are for introducing user input to the computer system and communicating that user input to central processing unit (CPU) 1213. Other suitable input devices may be used in addition to, or in place of, the mouse 1211 and keyboard 1210. I/O (input/output) unit 1219 coupled to bidirectional system bus 1218 represents such I/O elements as a printer, AN (audio/video) I/O, etc.

Computer 1200 includes a video memory 1214, main memory 1215 and mass storage 1212, all coupled to bi-directional system bus 1218 along with keyboard 1210, mouse 1211 and CPU 1213. The mass storage 1212 may include both fixed and removable media, such as magnetic, optical or magnetic optical storage systems or any other available mass storage technology. Bus 1218 may contain, for example, thirty-two address lines for addressing video memory 1214 or main memory 1215. The system bus 1218 also includes, for example, a 32-bit data bus for transferring data between and among the components, such as CPU 1213, main memory 1215, video memory 1214 and mass storage 1212. Alternatively, multiplex data/address lines may be used instead of separate data and address lines.

In one or more embodiments of the invention, CPU 1213 is a microprocessor manufactured by IBM, Intel, AMD, Sun Microsystems or any other manufacturer. However, any other suitable microprocessor or microcomputer may be utilized. Main memory 1215 is comprised of dynamic random access memory (DRAM).

Video memory 1214 is a dual-ported video random access memory. One port of the video memory 1214 is coupled to video amplifier 1216. The video amplifier 1216 is used to drive the cathode ray tube (CRT) raster monitor 1217. Video amplifier 1216 is well known in the art and may be implemented by any suitable apparatus. This circuitry converts pixel data stored in video memory 1214 to a raster signal suitable for use by monitor 1217. Monitor 1217 is a type of monitor suitable for displaying graphic images.

Computer 1200 may also include a communication interface 1220 coupled to bus 1218. Communication interface 1220 provides a two-way data communication coupling via a network link 1221 to a local network 1222. For example, if communication interface 1220 is an integrated services digital network (ISDN) card or a modem, communication interface 1220 provides a data communication connection to the corresponding type of telephone line, which comprises part of network link 1221. If communication interface 1220 is a local area network (LAN) card, communication interface 1220 provides a data communication connection via network link 1221 to a compatible LAN. Wireless links are also possible. In any such implementation, communication interface 1220 sends and receives electrical, electromagnetic or optical signals which carry digital data streams representing various types of information.

Network link 1221 typically provides data communication through one or more networks to other data devices. For example, network link 1221 may provide a connection through local network 1222 to host computer 1223 or to data equipment operated by an Internet Service Provider (ISP) 1224. ISP 1224 in turn provides data communication services through the world wide packet data communication network now commonly referred to as the “Internet” 1225. Local network 1222 and Internet 1225 both use electrical, electromagnetic or optical signals which carry digital data streams. The signals through the various networks and the signals on network link 1221 and through communication interface 1220, which carry the digital data to and from computer 1200, are exemplary forms of carrier waves transporting the information.

Computer 1200 can send messages and receive data, including program code, through the network(s), network link 1221, and communication interface 1220. In the Internet example, server 1226 might transmit a requested code for an application program through Internet 1225, ISP 1224, local network 1222 and communication interface 1220. In accord with the invention, one such downloaded application is the method and apparatus for creating, editing and displaying works containing time-dimensioned textual components described herein.

The received code may be executed by CPU 1213 as it is received, and/or stored in mass storage 1212, or other non-volatile storage for later execution. In this manner, computer 1200 may obtain application code in the form of a carrier wave.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the system may be implemented in any type of computer system or programming or processing environment.

Thus, a method and apparatus for peer-to-peer sales is provided.

1. A method for providing peer-to-peer sales comprising:
providing a computer based system for a seller to identify a product for sale through a network connection to the computer based system;
initiating through the computer system a plurality of directed queries to the seller through the network to determine information regarding the product;
entering system provided responses by the seller to the queries and entering seller created text by the seller in response to the queries;
transmitting the system provided responses and seller created text through the network to the computer based system;
at the computer based system, using results of the queries including system provided responses and user created text to determine a price range for the product;
providing the price range to the seller through the network;
the seller selecting a price from the price range and transmitting the selection through the network to the computer based system.

2. The method of claim 1 further including the steps of offering the seller a plurality of sales listing approaches and identifying a selection of one of the approaches by the seller.

3. The method of claim 1 further including the steps of having a seller independent inspection of the product and associating the results of the seller independent inspection with the product.

4. The method of claim 1 further including the steps of offering a buyer the opportunity to obtain a buyer independent inspection of the product and providing the results of the buyer independent inspection to the buyer.

5. The method of claim 4 wherein the buyer independent inspection is provided for no charge.

6. The method of claim 5 wherein the product is a vehicle.

7. The method of claim 6 wherein the seller and the buyer independent inspection is a vehicle inspection performed by a mechanic.

8. The method of claim 7 further including the steps of the seller offering a self-warranty on the vehicle for certain vehicle features at a fixed amount for a fixed time period.

9. The method of claim 8 further including a buyer having the buyer independent inspection performed within the fixed time period and receiving compensation up to the fixed amount for any necessary repairs of the vehicle features.

10. The method of claim 9 wherein the fixed time period is three days.
